(19) United States
(12) Patent Application Publication
(10) Pub. No.: US 2016/0239892 A1
(43) Pub. Date: Aug. 18, 2016

(54) USER INTEREST-BASED PRODUCT INFORMATION RECOMMENDATION SYSTEM

(71) Applicant: ODD CONCEPTS INC., Seoul (KR)

(72) Inventors: Jung Tae KIM, Seoul (KR); Jin Myeong AHN, Seoul (KR); Kyung Mo KOO, Busan (KR)

(21) Appl. No.: 14/904,299

(22) PCT Filed: Jul. 11, 2014
(86) PCT No.: PCT/KR2014/006245

§ 371 Date: Apr. 28, 2016

(30) Foreign Application Priority Data
Jul. 11, 2013 (KR) 10-2013-0081406

(51) Int. Cl. G06Q 30/06; G06K 9/62; G06K 9/46

(52) U.S. Cl. CPC G06Q 30/0619; G06Q 30/0625; G06Q 30/0641; G06K 9/46; G06K 9/6267

(57) ABSTRACT

A service server 100 stores commodity information including an image of a commodity for sale and extracts visual information on the commodity image in a form of image information. The service server 100 receives information on an image displayed on or provided at a webpage of a client 200, extracts visual information in the form of image information, and compares the extracted image information with pre-stored commodity image information. When there is a matching commodity, the service server 100 generates visual data, by which information on the commodity can be identified, and displays the generated visual data above or around the image displayed on the webpage of the client 200. Accordingly, a user can identify commodity image information displayed on the webpage or move to a purchase page during web surfing, thereby easily identifying additional information on an interested commodity during web surfing and purchasing the commodity in real time.

### BACKGROUND OF THE INVENTION

1. Field of the Invention

The present invention relates to a commodity information recommending system based on user interest, which, when an image is displayed on a webpage in a client such as a PC, a smart phone, or the like, moves to a commodity information page corresponding to the image or newly generates visual data on commodity information on one side of the webpage, so as to allow a user to easily identify the commodity information corresponding to the image.

2. Description of the Prior Art

In general, when a user purchases commodities through a client such as a PC, a smart phone, or the like online, the user uses a method of searching for a commodity to be purchased in an open market such as an e-commerce shopping mall and, when a desired commodity is found, moving to a purchase site and purchasing the commodity.

As described above, currently, the open market introduces various products and allows direct orders over the Internet, which makes customer's consumption easy.

However, in this case, when the user finds an interesting commodity during web surfing, the user must open another webpage, move to an open market, and then check a basic explanation, prices, and the like of the commodity through a process of searching for the commodity.

Accordingly, in order to solve the above described problem, it is required to develop a more novel and inventive commodity information providing system through which the user can easily identify commodity information even during web surfing to save time and order the commodity anytime for a more convenient and simple order of the consumer.

### SUMMARY OF THE INVENTION

An aspect of the present invention is to provide a commodity information recommending system based on user interest, which, when an image is displayed on a webpage of a client such as a PC, a smart phone, or the like, may move to a commodity information page corresponding to the image or newly generate visual data on commodity information on one side of the webpage so as to allow a user to easily identify the commodity information corresponding to the image.

Another aspect of the present invention is to provide a commodity information recommending system based on user interest, in which a website server may identify displaying of an image on the webpage of the client and move to a commodity information page corresponding to the image or newly generate visual data on commodity information so as to allow a user to easily identify the commodity information corresponding to the image.

A commodity information recommending system based on user interest according to a first embodiment of the present invention comprises:

a service server 100 and a client 200, wherein the service server 100 includes: a first commodity registration module 102 for storing a commodity image and commodity information in a commodity information DB 120;

a first commodity image information extraction module 104 for extracting feature points or visual attributes of the feature points from one or more images selected according to the purpose of a service among commodity images stored in the commodity information DB 120 of the first commodity registration module 102;

a first commodity classification module 106 for comparing image information on the commodity image extracted through the first commodity image information extraction module 104, classifying the image information to a group according to sameness or similarity, and arranging commodities in an order of one or more of price, registration date, popularity, and satisfaction of the commodities within each group;

a first client image reception module 108 for receiving an image displayed on a webpage from the client 200;

a first client image information extraction module 110 for extracting feature points or visual attributes of the feature points from the image received from the client 200 in the form of image information;

a first commodity search module 112 for comparing the image information on the image extracted through the first client image information extraction module 110 with registered image information on the commodity image and searching for a commodity image that matches exactly or similarly; and

a first commodity information transmission module 114 for matching commodity information corresponding to the commodity image found by the first commodity search module 112 with the received image and providing the commodity information which matches with the image, to the client 200, and

the client 200 includes:

a webpage image transmission module 202 for transmitting the image displayed on the webpage to the service server 100;

a first commodity information reception module 204 for receiving commodity information found through the first commodity information transmission module 114 of the service server 100; and

a first commodity information display module 206 for generating visual data in one form selected from a text form, button form, image form, and actionscript form, to which the commodity information received from the service server 100 is linked, exposing the visual data above or around the image displayed on the webpage and, when the visual data is clicked or a mouse cursor is located over the visual data, providing a link to additional information to show the additional information in a preview form,

wherein feature points extracted from the service server 100 refer to information generated by outlines, corners, or extremes (a darker part or a brighter part compared to ambient brightness) included in the image, and visual attributes of the feature points refer to information on an area configured based on brightness information, color information, or pattern information on images around the feature points.

Preferably, the commodity information of the first commodity registration module 102 may include one or more of a commodity sale page, a URL of a purchase page, price information, information on a shopping mall, and information on a commodity review.

Preferably, commodity information linked to the visual data through the first commodity information display module 206 of the client 200 may correspond to a URL of a commodity sale page and, when a user is registered as a member, corresponds to a URL of a commodity purchase page.

A commodity information recommending system based on user interest according to a second embodiment of the present invention comprises: a service server 100′, a client 200, and a website server 300,

wherein the service server 100′ includes:

a second commodity registration module 152 for storing a commodity image and commodity information;

a second commodity image information extraction module 154 for extracting feature points or visual attributes of the feature points from one or more images selected to serve the purpose of a service from commodity images stored in the commodity information DB 120 of the second commodity registration module 152 in the form of image information;

a second commodity classification module 156 for comparing image information on the commodity image extracted through the second commodity image information extraction module 154, classifying the image information to a group according to sameness or similarity, and arranging commodities in an order of one or more of price, registration date, popularity, and satisfaction of the commodities within each group;

a second client image reception module 158 for receiving an image displayed on a webpage of the client 200 from the website server 300;

a second client image information extraction module 160 for extracting feature points or visual attributes of the feature points from the image displayed in the client, which is received through the second client image reception module 158 in the form of image information;

a second commodity search module 162 for comparing the image information on the image received from the website server 300, which is extracted through the second client image information extraction module 160, with registered image information on the commodity image and searching for a commodity image that matches exactly or similarly; and

a second commodity information transmission module 164 for, when the second commodity search module 162 has found a registered commodity image corresponding to the image received from the website server 300, matching commodity information corresponding to the found commodity image with the received image and providing the commodity information which matches with the image, to the web site server 300, and

the website server 300 comprises:

a client image identification module 302 for, when an image is displayed on or provided at the webpage of the client 200, identifying information on the image;

a client image transmission module 304 for transmitting the image identified by the client image identification module 302 to the service server 100′;

a second commodity information reception module 306 for receiving commodity information corresponding to the image provided through the second commodity information transmission module 164 from the service server 100′; and

a second commodity information display module 308 for generating visual data in one form selected from a text form, button form, image form, and actionscript form, to which the commodity information received from the service server 100′ is linked, exposing the visual data above or around the image displayed on the webpage and, when a mouse cursor is located over the visual data, providing a link to additional information to show the additional information in a preview form,

wherein feature points extracted from the service server 100′ refer to information generated by outlines, corners, or extremes (a darker part or a brighter part compared to ambient brightness) included in the image, and visual attributes of the feature points refer to information on an area configured based on brightness information, color information, or pattern information on images around the feature points.

A commodity information recommending system based on user interest according to the present invention has an effect in that, when an image is displayed on a webpage during web surfing, a user who uses a client such as a PC, a smart phone, or the like can immediately identify commodity information such as cheapest price information on the commodity through visual data displayed around the image.

Further, there is an advantage in that the user can identify additional information such as a similar commodity, a recommended commodity, or information on a shopping mall by placing a mouse cursor on the visual data and move to a commodity sale or purchase page through a click, thereby reducing a process and time required for online shopping and activating a mobile-based commerce ecosystem.

### BRIEF DESCRIPTION OF THE DRAWINGS

The above and other objects, features and advantages of the present invention will be more apparent from the following detailed description taken in conjunction with the accompanying drawings, in which:

FIG. 1 schematically illustrates a configuration of a commodity information recommending system based on user interest according to a first embodiment of the present invention;

FIG. 2 is a block diagram of a service server according to the first embodiment of the present invention;

FIG. 3 is a detailed block diagram of a client according to the first embodiment of the present invention;

FIG. 4 is a flowchart illustrating a processing operation of the commodity information recommending system based on user interest according to the first embodiment of the present invention;

FIG. 5 schematically illustrates a configuration of a commodity information recommending system based on user interest according to a second embodiment of the present invention;

FIG. 6 is a block diagram of a service server according to the second embodiment of the present invention;

FIG. 7 is a detailed block diagram of a client according to the second embodiment of the present invention; and

FIG. 8 is a flowchart illustrating a processing operation of the commodity information recommending system based on user interest according to the second embodiment of the present invention.

### DETAILED DESCRIPTION OF THE EXEMPLARY EMBODIMENTS

Hereinafter, a commodity information recommending system based on user interest according to the present invention will be described in detail with reference to the accompanying drawings.

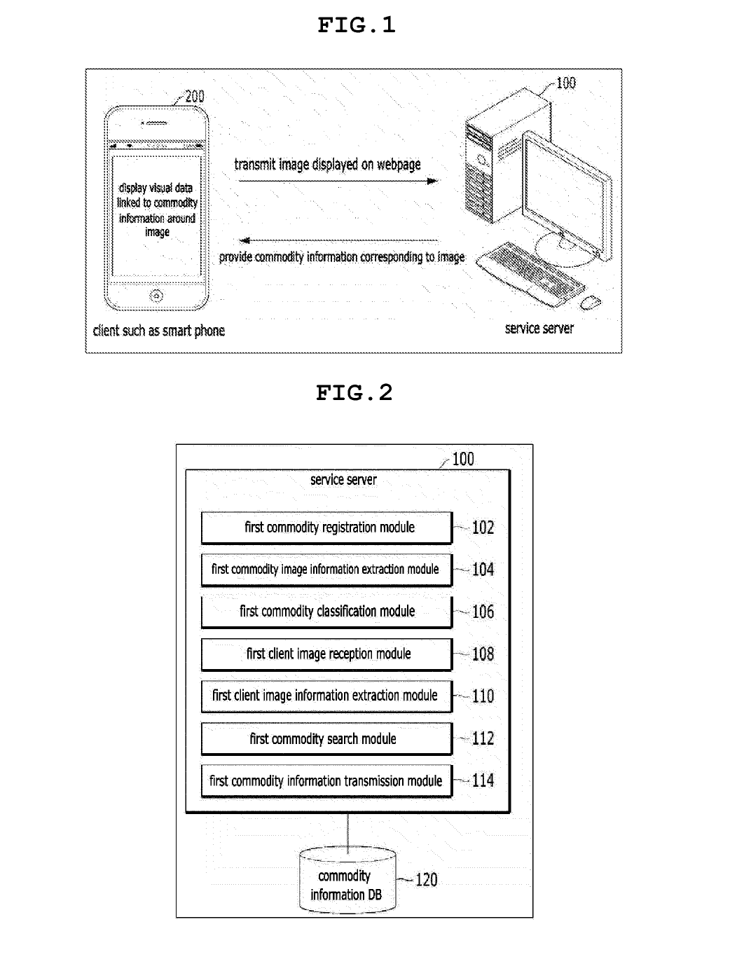

As illustrated in FIG. 1, based on a basic concept of a commodity information recommending system based on user interest according to a first embodiment of the present invention, a service server 100 stores commodity information including an image of a commodity for sale and extracts visual information on the commodity image in the form of image information. Further, the service server 100 receives information on an image displayed on a webpage of a client 200, extracts visual information in the form of image information, and compares the extracted image information with pre-stored image information on the commodity. In addition, when there is a matching commodity, the service server 100 generates visual data including information on a commodity sale in a link form, and displays the generated visual data above or around the image displayed on the webpage of the client 200. Accordingly, the user may receive, in real time, the information on the commodity in an image form displayed through the webpage during web surfing in the client and directly move to a sale page or a purchase page. As a result, if the user gets interested in a commodity during the web surfing, the user can easily identify additional information on the commodity and purchase the commodity.

Meanwhile, the visual information extracted from the image refers to feature points of the image or visual attributes of the feature points, the feature points refer to information generated by outlines, corners, or extremes (a darker part or a brighter part compared to ambient brightness) included in the image, and the visual attributes of the feature points refer to information on an area configured based on brightness information, color information, or pattern information on images around the feature points.

As illustrated in FIG. 2, the service server 100 according to the present invention may include a first commodity registration module 102, a first commodity image information extraction module 104, a first commodity classification module 106, a first client image reception module 108, a first client image information extraction module 110, a first commodity search module 112, and a first commodity information transmission module 114.

The first commodity registration module 102 stores an image of a commodity on sale and commodity information in a commodity information DB 120. At this time, the first commodity registration module 102 may collect the commodity information along with the image of the commodity from a website that provides a commodity purchase service, or search for an open market to collect the commodity information along with the image of the commodity for sale. The commodity information includes a commodity sale page, a URL of a purchase page, price information, information on a shopping mall, information on commodity review, and the like.

The first commodity image information extraction module 104 extracts feature points or visual attributes of the feature points from the image of the commodity stored in the commodity information DB 120 of the first commodity registration module 102. At this time, it is preferable that the first commodity registration module 102 extracts the visual attributes in the form of image information from one or more images selected to serve the purpose of a service in consideration of the fact that the collected commodity information generally includes a plurality of images such as a representative image and a detailed image.

The first commodity classification module 106 compares pieces of visual information of the commodity image extracted through the first commodity image information extraction module 104 to each other and classifies the pieces of visual information according to sameness or similarity therebetween. Accordingly, when there is a pre-registered image having the same or similar visual information, the first commodity classification module 106 may classify additionally found commodity information to be a group including the corresponding image. Further, data, which is arranged according to an order of one or more of price, a registration date, popularity, and satisfaction of commodities within each group, is also stored.

The first client image reception module 108 receives an image displayed on the webpage from the client 200. The image received from the client is provided when the image is displayed on the webpage through the webpage image transmission module 202 of the client, which will be described below.

The first client image information extraction module 110 extracts feature points or visual attributes of the feature points from the image received from the client 200 in the form of image information.

The first commodity search module 112 compares the image information on the image received from the client 200, which has been extracted through the first client image information extraction module 110, with registered image information on the commodity image and searches for a commodity image, which matches exactly or similarly.

When the first commodity search module 112 has found a commodity image corresponding to the image received from the client 200, the first commodity information transmission module 114 matches commodity information corresponding to the found commodity image with the received image and transmits the commodity information which matches the image, to the client 200. At this time, the commodity information provided to the client 200 corresponds to a sale page of the commodity, a URL of a purchase page, price information, and the like. Further, when there are a plurality of found commodities, price, registration date, popularity, satisfaction, information on a shopping mall, and the like may be selected sequentially.

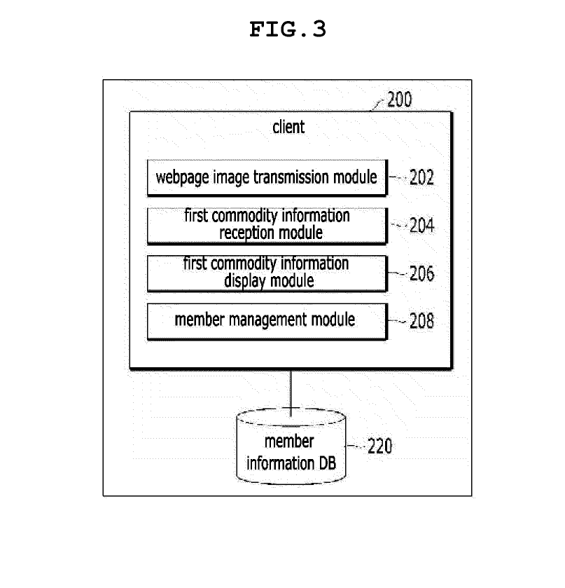

As illustrated in FIG. 3, an application installed in the client 200, a plug-in or an embedded program, or an inserted script communicates with the service server 100 and includes a webpage image transmission module 202, a first commodity information reception module 204, a first commodity information display module 206, and a member management module 208.

When an image is displayed on the webpage of the client 200, the webpage image transmission module 202 identifies the image and transmits the identified image to the service server 100. At this time, when a plurality of images are displayed on the webpage, it is preferable to assign a unique ID to each of the images and then transmit the images to the service server 100.

The first commodity information reception module 204 receives commodity information corresponding to the image of the webpage provided through the first commodity information transmission module 114 of the service server 100.

The first commodity information display module 206 newly generates visual data (for example, commodity information identification part) including the commodity information, which has been provided from the service server 100, in a link form and exposes the generated visual data above or around the image displayed on the webpage. At this time, the visual data may be created in a text form, a button form, an image form, an actionscript form, or the like, linked to the commodity information. Meanwhile, the first commodity information display module 206 basically links a commodity sale page. When a user is registered by a user registration unit described below, it is preferable to directly link a commodity purchase page. Further, when a mouse cursor is located over the visual data, a link may be provided to show additional information in a preview form. Accordingly, even though a plurality of images exist on the user webpage, the visual data is displayed above or around only an image, which matches the commodity information from the service server 100, without being displayed above or around an image, which does not match the commodity information.

The member management module 208 registers information on a client user as member information and stores the member information in a member information DB 220.

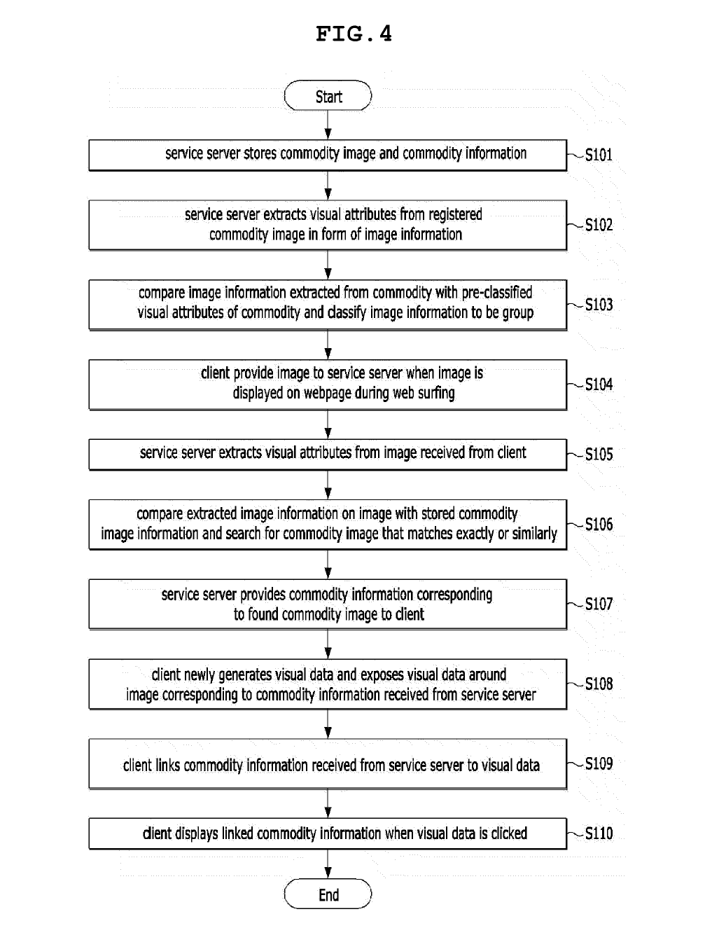

A process of an operation of the commodity information recommending system based on user interest according to the present invention will be described in detail with reference to a flowchart of FIG. 4.

First, the service server 100 stores a commodity image and commodity information in the commodity information DB 120 in step S101. At this time, it is preferable to collect the commodity information from a website, which provides a commodity purchase service, along with the image of the commodity. Further, the commodity information includes a URL movable to a sale page of the commodity, a URL of a purchase page, price information, information on a shopping mall, information on commodity review, and the like.

In addition, the service server 100 extracts feature points or visual attributes of the feature points from a registered commodity image in the form of image information in step S102, and compares the extracted feature points or visual attributes with visual attributes of a pre-classified commodity to classify the visual attributes to be the existing group according to sameness or similarity and, when there is no existing group, classifies the visual attributes to be a new group in step S103. At this time, when there are a representative image and a detailed image in the collected commodity images, the service server 100 may extract visual attributes from one or more images selected according to the purpose of a service in the form of image information. Further, the commodities included in each group are arranged according to an order of one or more of price, a registration date, popularity, and satisfaction.

Meanwhile, when a page including an image is displayed on the webpage while the user performs web surfing, the client 200 recognizes the image and provides the image to the service server 100 in step S104. At this time, when a plurality of images exist in a plurality of webpages, unique IDs are assigned to the images and the images are provided to the service server 100. The client 200 may provide only attribute information on the recognized image to the service server 100. For example, when an image for a smart phone is displayed along with an article for the latest smart phone while the user surfs a news site, the client 200 provides the image for the smart phone to the service server 100.

The service server 100 having received the image in the webpage from the client 200 extracts feature points or visual attributes of the feature points from the image received from the client 200 in the form of image information in step S105, and compares the extracted image information with stored image information on the commodity image and searches for a commodity image which matches exactly or similarly in step S106. When the matching commodity image is found based on a result of the search, the service server 100 provides commodity information corresponding to the commodity image to the client in step S107. For example, when the client 200 receives the image for the smart phone, the client 200 extracts image information on the smart phone image, compares the extracted image information with pre-registered image information, and selects registered commodity information on the smart phone.

When the client 200 receives the commodity information from the service server 100, the client 200 newly generates visual data including a link and exposes the visual data above or around the webpage image corresponding to the commodity information in step S108, and links the visual data to the commodity information received from the service server 100 in step S109. The visual data is generally linked to a commodity sale page, and it is preferable that the visual data is linked to a commodity purchase page when the user is registered as a member. Further, when a mouse cursor is located over the visual data, a link may be provided to show additional information in a preview form.

Accordingly, the user who performs web surfing through the client 200 may directly identify price information based on visual information displayed above or around the commodity image in the webpage, identity additional information by placing a mouse cursor thereon, identify accurate commodity information through a click, or directly move to a purchase page to purchase the commodity in step S110.

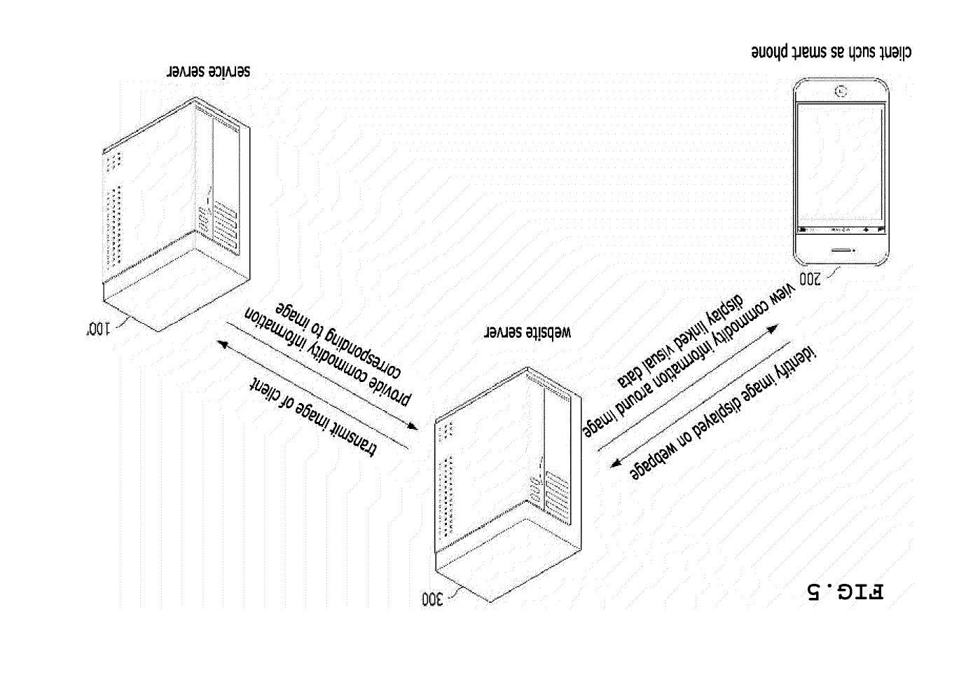

As illustrated in FIG. 5, based on a basic concept of the commodity information recommending system based on user interest according to a second embodiment of the present invention, when a website server 300 transmits information on an image displayed on or provided at a webpage of the client 200 to a service server 100′, the service server 100′ compares image information on the image received from the website server 300 with pre-stored commodity image information and transmits commodity sale information on a matching commodity image to the website server 300. The website server 300 generates visual data including information on the commodity sale in a link form, and displays the generated visual data above or around the image displayed on the webpage of the client 200.

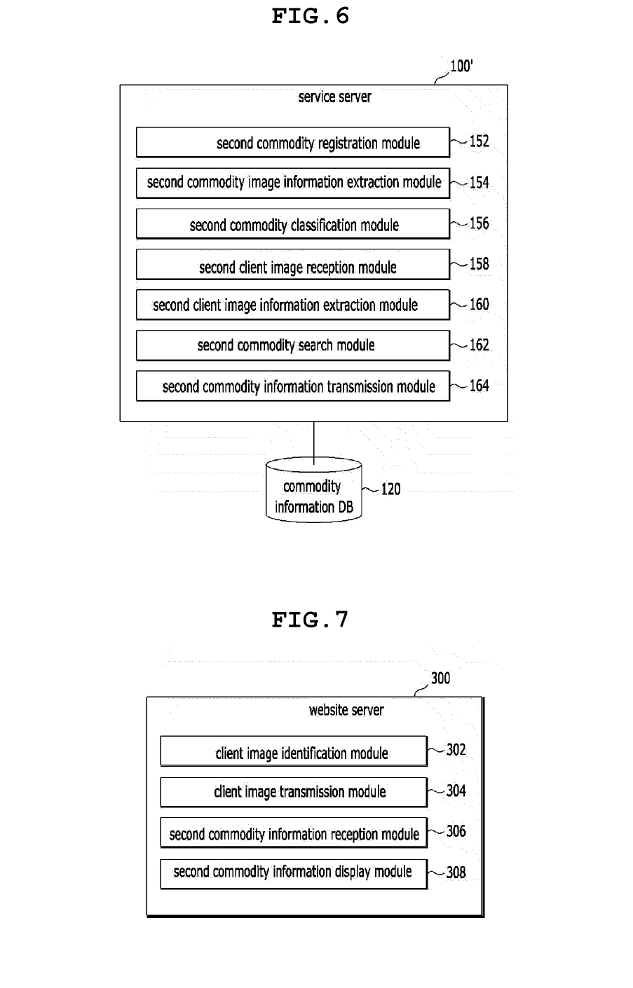

As illustrated in FIG. 6, the service server 100′ according to the present invention may include a second commodity registration module 152, a second commodity image information extraction module 154, a second commodity classification module 156, a second client image reception module 158, a second client image information extraction module 160, a second commodity search module 162, and a second commodity information transmission module 164. At this time, since the second commodity registration module 152, the second commodity image information extraction module 154, and the second commodity classification module 156 of the service server have the same functions as those of the first commodity registration module 102, the first commodity image information extraction module 104, and the first commodity classification module 106 according to the first embodiment, detailed descriptions thereof will be omitted.

The second client image reception module 158 receives the image displayed on or provided at the webpage of the client 200 from the website server 300.

The second client image information extraction module 160 extracts feature points or visual attributes of the feature points from the image received through the second client image reception module 158.

The second commodity search module 162 compares the image information on the image received from the web site server 300, which has been extracted through the second client image information extraction module 160, with registered image information on the commodity image and searches for a commodity image, which matches exactly or similarly.

When the second commodity search module 162 has found the registered commodity image corresponding to the image received from the website server 300, the second commodity information transmission module 164 matches commodity information corresponding to the found commodity image with the received image and transmits the commodity information which matches with the image, to the website server 300.

As illustrated in FIG. 7, the website server 300 communicates the service server 100′ and the client 200, and includes a client image identification module 302, a client image transmission module 304, a second commodity information reception module 306, and a second commodity information display module 308.

The client image identification module 302 identifies information on the image displayed on or provided at the webpage of the client 200. The image displayed on the webpage of the client 200 may be provided and identified through an application installed in the client 200, a plug-in or an embedded program, or an inserted script. Further, the image provided at the webpage of the client may be identified through an application installed in the website server, a plug-in or an embedded program, or an inserted script.

The client image transmission module 304 transmits the image identified by the client image identification module 302 to the service server 100′. At this time, when a plurality of images are displayed on the webpage, it is preferable to assign a unique ID to each of the images and then transmit the images to the service server 100′.

The second commodity information reception module 306 receives commodity information corresponding to the image provided through the second commodity information transmission module 164 from the service server 100′.

The second commodity information display module 308 newly generates visual data (for example, commodity information identification part) including the commodity information, which has been provided from the service server 100′, in a link form and exposes the generated visual data above or around the image displayed on the webpage of the client. At this time, the visual data may be created in a text form, a button form, an image form, an actionscript form, or the like, linked to the commodity information. Meanwhile, the second commodity information display module 308 basically links a commodity sale page. When a user is registered by a user registration unit described below, it is preferable to directly link a commodity purchase page. Further, when a mouse cursor is located at the visual data, a link may be provided to show additional information in a preview form.

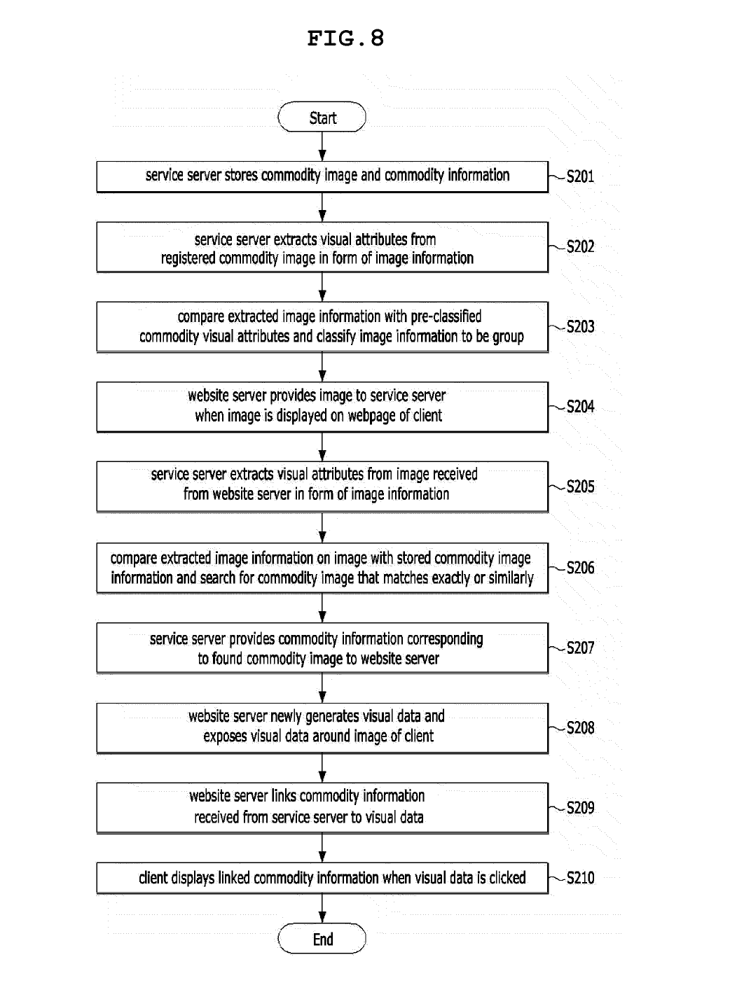

A process of an operation of the commodity information recommending system based on user interest according to the second embodiment of the present invention will be described in detail with reference to a flowchart of FIG. 8.

First, the service server 100′ stores a commodity image and commodity information in the commodity information DB 120 in step S201.

Further, the service server 100′ extracts feature points or visual attributes of the feature points from a registered commodity image in the form of image information in step S202, and compares the extracted feature points or visual attributes with visual attributes of a pre-classified commodity to classify the visual attributes to be the existing group according to sameness or similarity and, when there is no existing group, classifies the visual attributes to be a new group in step S203.

Meanwhile, when the image is displayed on or provided at the webpage of the client 200, the website server 300 recognizes the image and provides the image to the service server 100′ in step S204. At this time, when a plurality of images exist in a plurality of webpages, unique IDs are assigned to the images and the images are provided to the service server 100′.

The service server 100′ extracts feature points or visual attributes of the feature points from the image received from the website server 300 in the form of image information in step S205, and compares the extracted image information with stored image information on the commodity image and searches for a commodity image which matches exactly or similarly in step S206. When the matching commodity image is found based on a result of the search, the service server 100′ provides commodity information corresponding to the commodity image to the website server 300 in step S207.

When the website server 300 receives the commodity information from the service server 100′, the website server 300 newly generates visual data including a link and exposes the visual data above or around the image on the webpage of the client in step S208, and links the visual data to the commodity information received from the service server 100′ in step S209. The visual data is basically linked to a commodity sale page. Further, when a mouse cursor is located over the visual data, a link may be provided to show additional information in a preview form.

Accordingly, the user who performs web surfing through the client 200 may directly identify price information based on visual data displayed above or around the commodity image in the webpage, identity additional information by placing a mouse cursor thereon, identify accurate commodity information through a click, or directly move to a purchase page to purchase the commodity in step S210.

As described above, although the present invention has been described with reference to the limited embodiments and drawings, the present invention is not limited thereto, and it is apparent that various modifications and changes can be made within the technical idea of the present invention and the equivalent to the claims below by those skilled in the art.

What is claimed is:

1. A system for recommending commodity information, the system comprising:
a service server 100 and a client 200,
wherein the service server 100 comprises:
a first commodity registration module 102 for storing a commodity image and commodity information in a commodity information DB 120;
a first commodity image information extraction module 104 for extracting feature information on the commodity image stored in the commodity information DB 120 of the first commodity registration module 102;
a first commodity classification module 106 for classifying the feature information on the commodity image extracted through the first commodity image information extraction module 104 into one or more groups according to a preset reference;
a first client image reception module 108 for receiving an image displayed on a webpage from the client 200;
a first client image information extraction module 110 for extracting feature information on the image received from the client 200;
a first commodity search module 112 for comparing the feature information on the image extracted through the first client image information extraction module 110 with classification information of the first commodity classification module 106 and searching for a commodity image that matches exactly or similarly; and
a first commodity information transmission module 114 for providing commodity information corresponding to the commodity image found by the first commodity search module 112 to the client 200, and
the client 200 comprises:
a webpage image transmission module 202 for transmitting the image displayed on the webpage to the service server 100;
a first commodity information reception module 204 for receiving commodity information through the first commodity information transmission module 114 of the service server 100; and
a first commodity information display module 206 for generating the commodity information in one form of visual data selected from a linked text form, button form, image form, and actionscript form and exposing the commodity information above or around the image displayed on the webpage and, when the visual data is clicked or a mouse cursor is located over the visual data, providing a link to additional information to show the additional information in a preview form.

2. The system of claim 1, wherein the first commodity image information extraction module 104 extracts at least one of outlines, corners, and extremes included in the image as feature points of the image and extracts feature information on the image by using at least one of brightness information, color information, and pattern information on the feature points.

3. The system of claim 1, wherein the first commodity registration module 102 collects the commodity information along with the commodity image from a website that sells the commodity.

4. The system of claim 1, wherein the commodity information of the first commodity registration module 102 includes one or more of a commodity sale page, a URL of a purchase page, price information, information on a shopping mall, and information on a commodity review.

5. The system of claim 1, wherein the webpage image transmission module 202 of the client 200 assigns a unique ID to each image displayed on the webpage and then transmits the image to the service server 100.

6. The system of claim 1, wherein the client 200 further comprises a member management module 208 for registering information on a user as member information and storing the information in a member information DB 220.

7. The system of claim 1, wherein commodity information linked to the visual data through the first commodity information display module 206 corresponds to a URL of a commodity sale page and, when a user is registered as a member, corresponds to a URL of a commodity purchase page.

8. A system for recommending commodity information, the system comprising:
a service server 100′, a client 200, and a website server 300,
wherein the service server 100′ comprises:
a second commodity registration module 152 for storing a commodity image and commodity information;
a second commodity image information extraction module 154 for extracting feature information on one or more images selected to serve the purpose of a service from commodity images stored in the commodity information DB 120 of the second commodity registration module 152;
a second commodity classification module 156 for classifying the feature information on the commodity images extracted through the second commodity image information extraction module 154 into one or more groups according to a preset reference;
a second client image reception module 158 for receiving an image displayed on a webpage of the client 200 from the website server 300;
a second client image information extraction module 160 for extracting feature information on the image displayed in the client, which is received through the second client image reception module 158;
a second commodity search module 162 for comparing the feature information on the image received from the website server 300, which is extracted through second client image information extraction module 160 with classification information of the second commodity classification module 106 and searching for a commodity image that matches exactly or similarly; and
a second commodity information transmission module 164 for, when the second commodity search module 162 has found a registered commodity image corresponding to the image received from the website server 300, providing commodity information corresponding to the found commodity image to the website server 300, and
the website server 300 comprises:
a client image identification module 302 for, when an image is displayed on or provided at the webpage of the client 200, identifying information on the image;
a client image transmission module 304 for transmitting the image identified by the client image identification module 302 to the service server 100′;
a second commodity information reception module 306 for receiving commodity information corresponding to the image provided through the second commodity information transmission module 164 from the service server 100′; and
a second commodity information display module 308 for generating the commodity information, which is received from the service server 100′, in one form of visual data selected from a linked text form, button form, image form, and actionscript form and exposing the commodity information above or around the image displayed on the webpage of the client and, when a mouse cursor is located over the visual data, providing a link to additional information to show the additional information in a preview form.

9. The system of claim 8, wherein the image displayed on the webpage of the client 200 is provided through an application installed in the client 200 or the website server 300, a plug-in or an embedded program, or an inserted script.
